(19) United States
(12) Patent Application Publication
(10) Pub. No.: US 2025/0181114 A1
(43) Pub. Date: Jun. 5, 2025

(54) LAPTOP COMPUTER

(71) Applicant: Acer Incorporated, New Taipei City (TW)

(72) Inventors: Jui-Yi YU, New Taipei City (TW); Hui-Ping SUN, New Taipei City (TW); Chun-Hsien CHEN, New Taipei City (TW); Chun-Hung WEN, New Taipei City (TW); Yen-Chou CHUEH, New Taipei City (TW)

(21) Appl. No.: 18/747,594

(22) Filed: Jun. 19, 2024

(30) Foreign Application Priority Data
Nov. 30, 2023 (TW) 112146467

(51) Int. Cl. G06F 1/16

(52) U.S. Cl. CPC G06F 1/1637; G06F 1/1607; G06F 1/1616; G06F 1/1681; G06F 2200/1632

(57) ABSTRACT

A laptop computer is provided, including a main body and a display unit pivotally connected to each other. When the display unit is unfolded relative to the main body, a gear set inside the display unit rotates and drives a frame to move via a rack structure. Thus, the frame and a stylus pen in the frame move out of an opening in the front cover of the display unit so that the user can take out the stylus pen easily.

### CROSS REFERENCE TO RELATED APPLICATIONS

This application claims priority of Taiwan Patent Application No. 112146467, filed on Nov. 30, 2023, the entirety of which is incorporated by reference herein.

### BACKGROUND OF THE INVENTION

### Field of the Invention

The present invention relates to a laptop computer, and, in particular, to a laptop computer having a gear set and a rack structure.

### Description of the Related Art

In a conventional laptop computer with a stylus pen, a hole is usually formed on the lateral side of the display to receive the stylus pen. However, the small dimensions of the hole make it difficult to take out the stylus pen.

Additionally, when the display is unfolded relative to the main body, the cooling vents on the rear side of the main body may be blocked by the display and reduce the heat dissipation performance of the laptop computer.

Therefore, designing a laptop computer capable of high cooling efficiency and easy use so that the user can take out the stylus pen easily becomes a challenge.

### BRIEF SUMMARY OF THE INVENTION

An embodiment of the present invention provides a laptop computer that includes a main body, a display unit, a connecting member, a rack structure, a longitudinal frame, and a gear set. The display unit has a display and a connecting module connected to each other, wherein the connecting module is pivotally connected to the main body and has a housing, a front panel connected to the housing, and a movable member movably disposed on the bottom side of the front panel. The connecting member is disposed in the housing and connected to the movable member. The rack structure is disposed on the connecting member. The longitudinal frame is disposed in the movable member. The gear set is connected between the main body and the rack structure, wherein when the display unit is unfolded relative to the main body, the gear set impels the connecting member, the movable member, and the frame in a first direction via the rack structure.

In some embodiments, the housing forms a slope surface, and when the display unit is unfolded relative to the main body, the frame slides out of the movable member along the slope surface.

In some embodiments, the housing has a protruding portion, and the slope surface is formed on the protruding portion.

In some embodiments, wherein the front panel forms an opening, and the frame moves through the opening in a second direction when the display unit is unfolded relative to the main body.

In some embodiments, wherein the second direction is perpendicular to the first direction.

In some embodiments, wherein the rack structure is perpendicular to the frame.

In some embodiments, the laptop computer further includes a hinge affixed to the main body, wherein the gear set has a gear affixed to the hinge.

In some embodiments, a stylus pen is received in the frame, and when the display unit is folded relative to the main body, the frame and the stylus pen are hidden inside the movable member.

In some embodiments, the laptop computer further includes a hinge pivotally connecting the display to the connecting module.

In some embodiments, the laptop computer further includes a resilient member connected between the frame and the housing.

### BRIEF DESCRIPTION OF THE DRAWINGS

The present invention can be more fully understood by reading the subsequent detailed description and examples with references made to the accompanying drawings, wherein:

FIG. 1 is a perspective diagram showing a laptop computer 100 in accordance with an embodiment of the invention.

FIG. 2 is a partial enlarged view of the connecting module 20 in FIG. 1 that is pivotally connected to the main body 10 via the gear set G and the hinge h.

FIG. 3 is a perspective diagram showing the connecting module 20 with the front panel 22 and the covers 24 removed therefrom.

FIG. 4 is a partial enlarged perspective view showing the housing 21, the gear set G, the rack structure R, the movable member 23, the connecting member 25, the frame F, and the stylus pen P in FIG. 3 after assembly.

FIG. 5 is a perspective view showing the gear set G, the rack structure R, the movable member 23, the connecting member 25, the frame F, and the stylus pen P in FIG. 3 after assembly.

FIG. 6 is a cross-sectional view showing the movable member 23 located at a first height along the Z axis, wherein the stylus pen P and the frame F are located in a first position and received inside the movable member 23.

FIG. 7 is a perspective diagram that shows the connecting member 25, the movable member 23, the stylus pen P, and the frame F when moving in the Z direction relative to the housing 21.

FIG. 8 is a partial enlarged view of FIG. 8 that shows the connecting member 25, the movable member 23, the stylus pen P, and the frame F when moving in the Z direction relative to the housing 21.

FIG. 9 is a perspective diagram that shows the gear set G, the rack structure R, the connecting member 25, the movable member 23, the stylus pen P, and the frame F in FIG. 7.

FIG. 10 is a cross-sectional view of the stylus pen P when moving relative to the housing 21 from the first position of FIG. 6 to the second position.

FIG. 11 is an exploded diagram of the movable member 23, the stylus pen P, and the frame F.

FIG. 12 is a partial perspective diagram showing a resilient member E connected between the frame F and the housing 21 of the connecting module 20.

### DETAILED DESCRIPTION OF THE INVENTION

The following description is made for the purpose of illustrating the general principles of the invention and should not be taken in a limiting sense. The scope of the invention is best determined by reference to the appended claims.

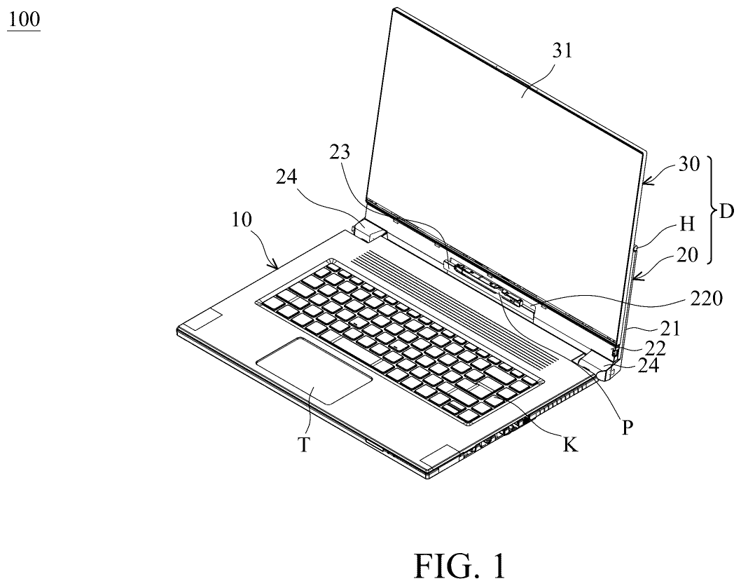

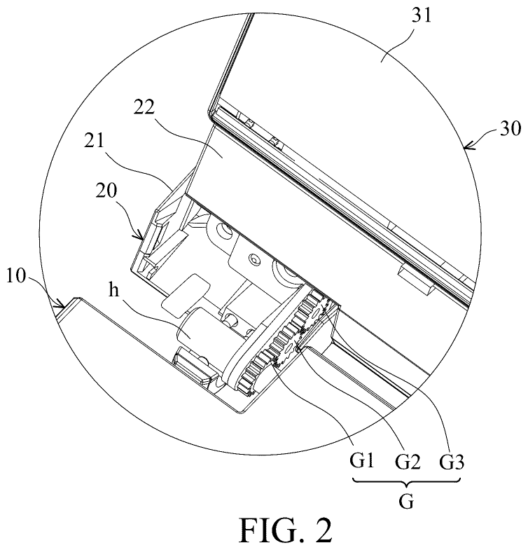

FIG. 1 is a perspective diagram showing a laptop computer 100 in accordance with an embodiment of the invention. FIG. 2 is a partial enlarged view of the connecting module 20 in FIG. 1 that is pivotally connected to the main body 10 via the gear set G and the hinge h.

Referring to FIGS. 1 and 2, the laptop computer 100 primarily comprises a display unit D and a main body 10 hinged to each other. The display unit D includes a connecting module 20, a display 30, and a hinge H, wherein the display 30 is pivotally connected to the connecting module 20 via the hinge H.

In this embodiment, the display 30 has a screen 31 (e.g. LCD, OLED or touch screen). Additionally, a keyboard K (e.g. QWERTY keyboard) and a touchpad T are disposed on the upper surface of the main body 10, whereby the users can easily use the laptop computer 100.

It should be noted that the keyboard K and/or the touchpad T can be used as a user input interface. When the display unit D is unfolded relative to the main body 10, the users can input the instructions or control the mouse cursor on the screen D of the display 30 through the keyboard K and/or the touchpad T.

Here, the connecting module 20 has a housing 21, a front panel 22, a movable member 23, and two covers 24. The front panel 22 is mounted to the housing 21, and the housing 21 is pivotally connected to the display 30 via the hinge H. The movable member 23 is disposed on the bottom side of the front panel 2. Moreover, the front panel 22 forms an opening 220 (FIG. 1), and a stylus pen P inside the housing 21 can be moved out of the housing 21 through the opening 220, whereby the user can take out the stylus pen P easily.

The covers 24 are connected to the housing 21 thus covering and protecting the hinge h and the gear set G (FIG. 2), wherein the hinge h is affixed to the main body 10. In this embodiment, the gear set G includes three gears G1, G2, and G3 engaged with each other. However, the number of the gears is not limited to the embodiment depicted in FIG. 2.

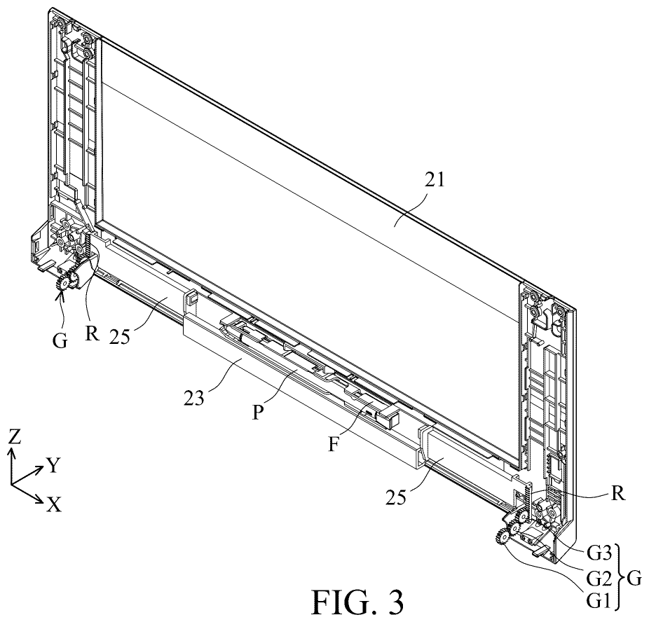

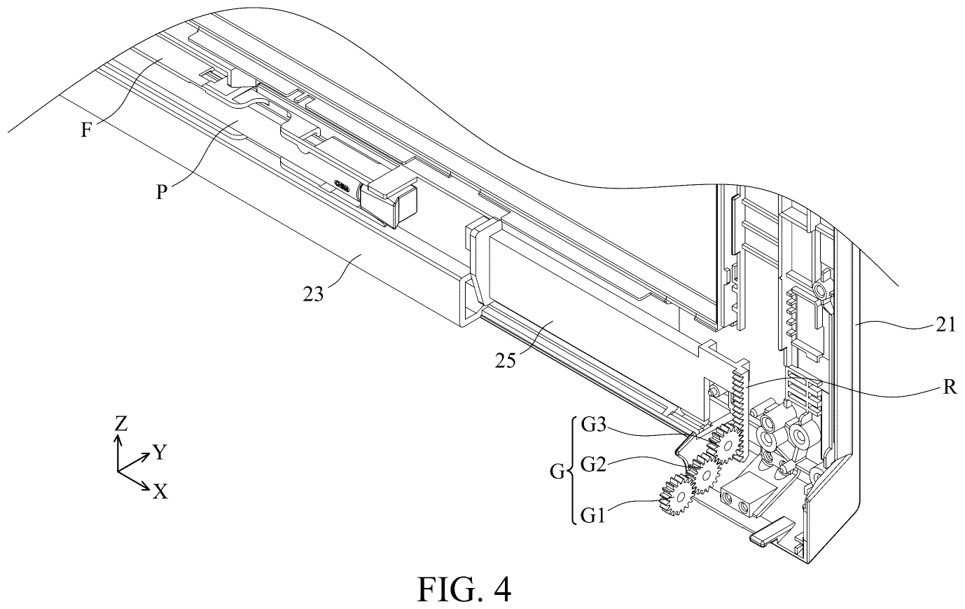

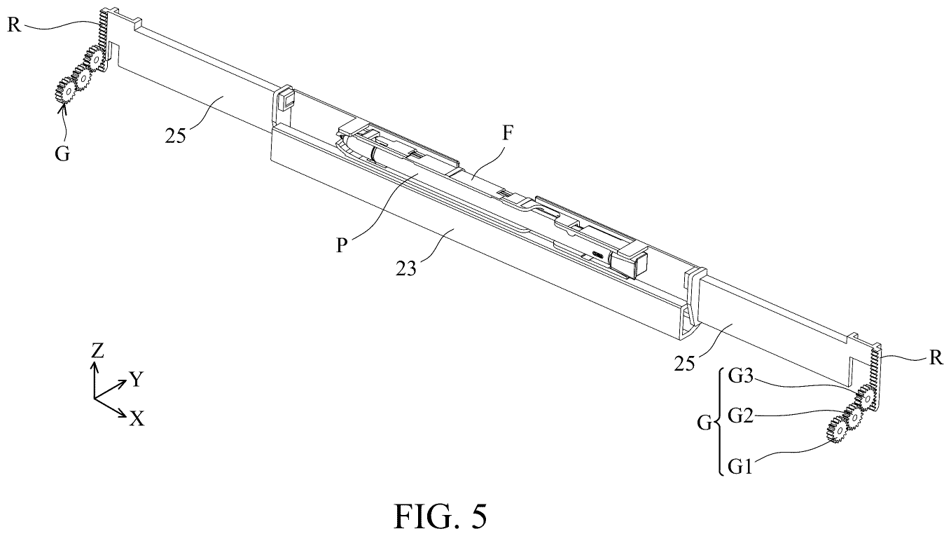

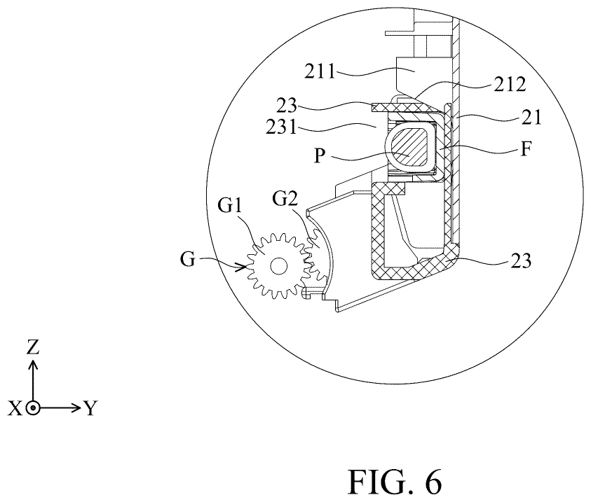

FIG. 3 is a perspective diagram showing the connecting module 20 with the front panel 22 and the covers 24 removed therefrom. FIG. 4 is a partial enlarged perspective view showing the housing 21, the gear set G, the rack structure R, the movable member 23, the connecting member 25, the frame F, and the stylus pen P in FIG. 3 after assembly. FIG. 5 is a perspective view showing the gear set G, the rack structure R, the movable member 23, the connecting member 25, the frame F, and the stylus pen P in FIG. 3 after assembly. FIG. 6 is a cross-sectional view showing the movable member 23 located at a first height along the Z axis, wherein the stylus pen P and the frame F are located in a first position and received inside the movable member 23.

Referring to FIGS. 2, 3, 4, 5, and 6, two gear sets G and two rack structures R are disposed on opposite sides of the connecting module 20. A gear G1 of the gear set G is affixed to the hinge h (FIG. 2), and another gear G3 of the gear set G is engaged with the rack structure R. In this embodiment, the rack structure R is integrally formed with the connecting member 25 in one piece. However, in some embodiments, the rack structure R may be affixed to an end of the connecting member 25 with adhesive or screws, and the invention is not limited to the embodiments presented and discussed above.

As shown in FIGS. 4 and 5, the connecting members 25 are connected to the opposite ends of the movable member 23. Furthermore, a longitudinal frame F is disposed at the center of the movable member 23, and the stylus pen P is received in the frame F. Here, the rack structure R is substantially perpendicular to the frame F and the stylus pen P.

It should be noted that the movable member 23, the connecting member 25, and the frame F are movably accommodated in the housing 21 and can be lifted up or lowered down along the Z axis. When the laptop computer 100 is closed, as shown in FIG. 6, the display unit D is in a closed position relative to the main body 10, and the movable member 23 is at a first height along the Z axis. In this state, the stylus pen P and the frame F are located in a first position and hidden inside the movable member 23, wherein the stylus pen P and the frame F do not protrude from the movable member 23 in the −Y direction.

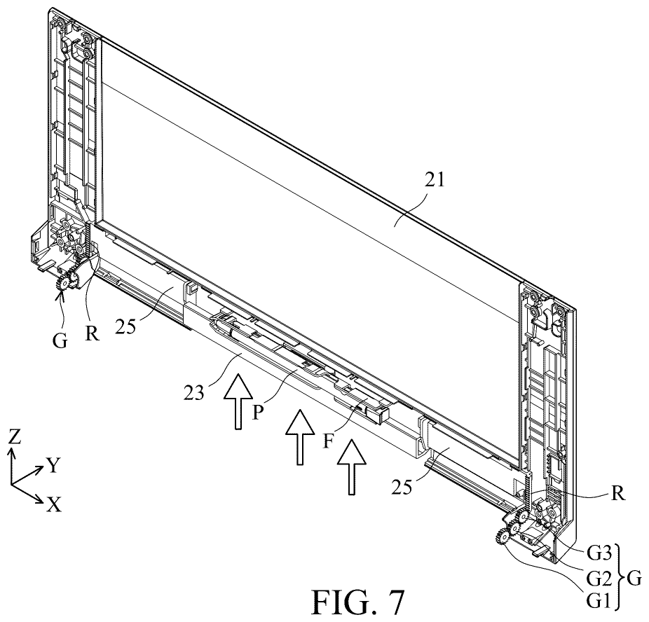

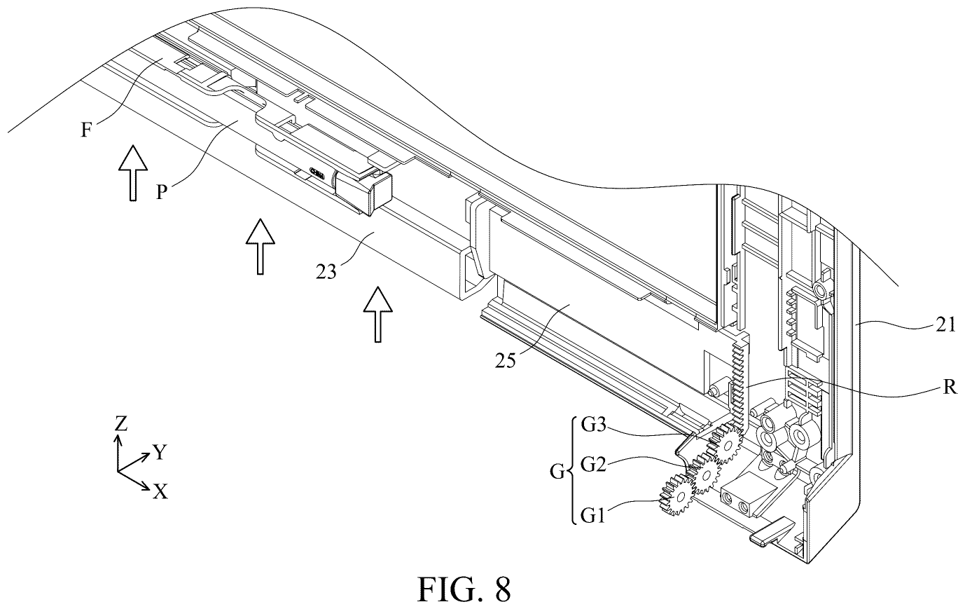

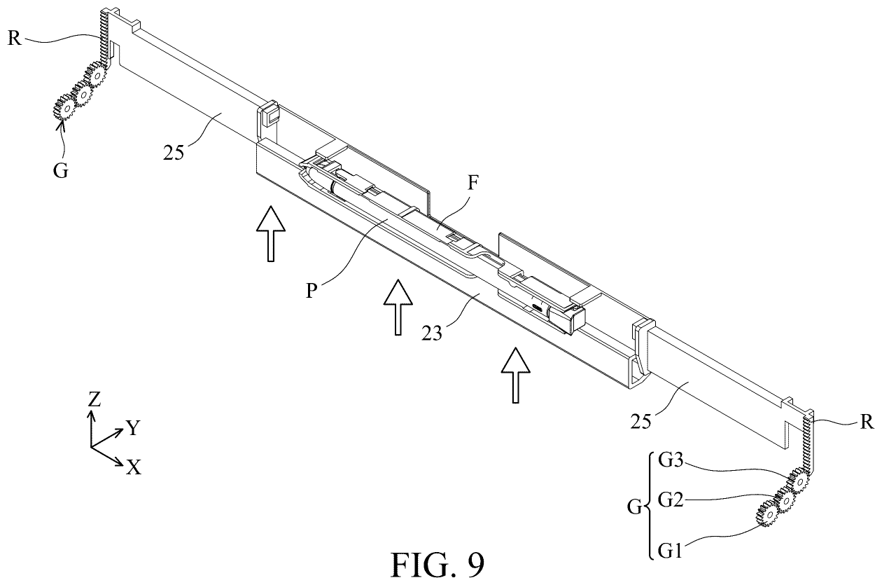

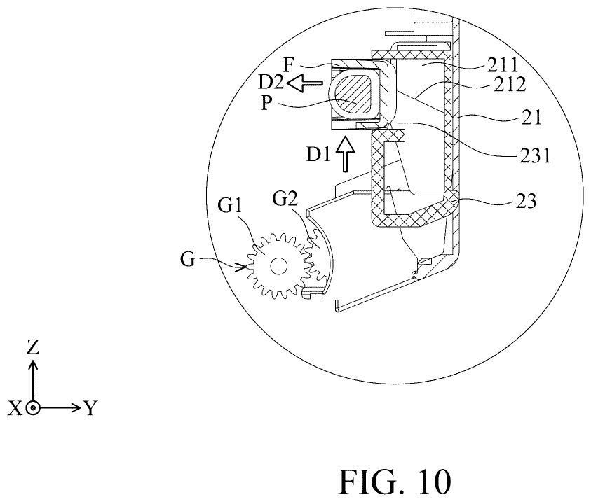

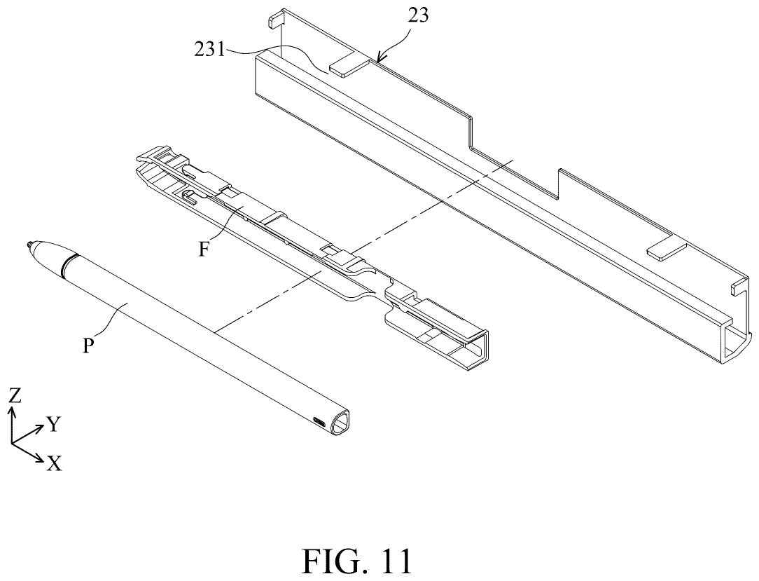

FIG. 7 is a perspective diagram that shows the connecting member 25, the movable member 23, the stylus pen P, and the frame F when moving in the Z direction relative to the housing 21. FIG. 8 is a partial enlarged view of FIG. 8 that shows the connecting member 25, the movable member 23, the stylus pen P, and the frame F when moving in the Z direction relative to the housing 21. FIG. 9 is a perspective diagram that shows the gear set G, the rack structure R, the connecting member 25, the movable member 23, the stylus pen P, and the frame F in FIG. 7. FIG. 10 is a cross-sectional view of the stylus pen P when moving relative to the housing 21 from the first position of FIG. 6 to the second position. FIG. 11 is an exploded diagram of the movable member 23, the stylus pen P, and the frame F.

When using the laptop computer 100, the display unit D can be unfolded relative to the main body 10. In this state, as shown in FIGS. 7, 8, 9, 10, and 11, the gears G1, G2, and G3 are driven to rotate so that the rack structure R, the connecting member 25, the movable member 23, and the frame F are lifted up in the Z direction.

During the movement of the connecting member 25, the movable member 23, and the frame F relative to the housing 21 along the Z direction, as per the first direction D1 shown in FIG. 10, the frame F contacts and slides along the slope surface 212 on the protruding portion 211 of the housing 21. Therefore, the frame F and the stylus pen P in the frame F can move and protrude out through the opening 231 of the movable member 23 and the opening 220 of the front panel 22 (FIG. 1), as per the second direction D2 shown in FIG. 10, whereby the user can take out the stylus pen P easily.

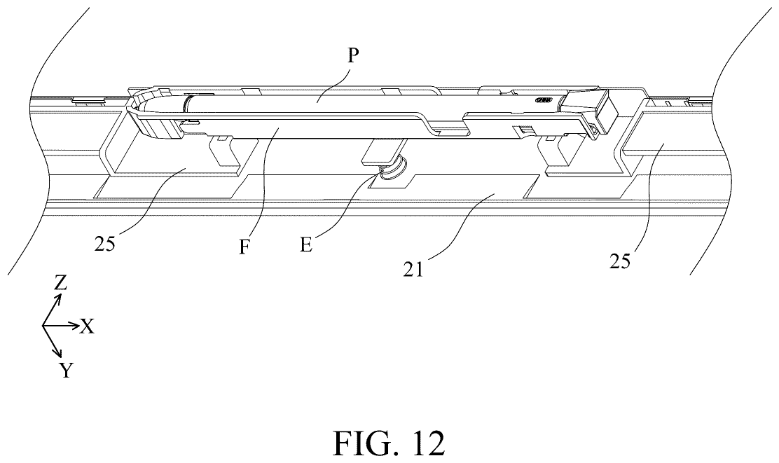

FIG. 12 is a partial perspective diagram showing a resilient member E connected between the frame F and the housing 21 of the connecting module 20.

Referring to FIG. 12, in another embodiment of the invention, a resilient member E (e.g. spring) may be provided between the frame F and the housing 21 of the connecting module 20, and the housing 21 does not form the protruding portion 211 and the slope surface 212 as shown in FIG. 10. Hence, the frame F and the stylus pen P in the frame F can be forced by the resilient member E to move and protrude out through the opening 231 of the movable member 23 and the opening 220 of the front panel 22, as per the second direction D2 shown in FIG. 10, whereby the user can take out the stylus pen P easily. In this embodiment, the second direction D2 is perpendicular to the first direction D1.

In summary, the invention provides a laptop computer 100 that has a stylus pen P and a frame F received in the connecting module 20 when in a closed state (FIG. 6). When using the laptop computer 100, the display unit D can be unfolded relative to the main body 10, whereby the gears G1, G2, and G3 are driven to rotate, and the rack structure R, the connecting member 25, the movable member 23, and the frame F are lifted up in the Z direction. Specifically, the frame F and the stylus pen P in the frame F can move and protrude out through the opening 231 of the movable member 23 and the opening 220 of the front panel 22 by the frame F sliding along the slope surface 212 on the housing 21 (FIG. 10) or by the resilient member E connected between the frame F and the connecting module 20 (FIG. 12). Therefore, the user can take out the stylus pen P easily.

As the connecting member 25 is lifted up relative to the housing 21 of the connecting module 20 in the Z direction when the display unit D is unfolded relative to the main body 10, the cooling vents on the rear side of the main body 10 would not be blocked by the connecting member 25, thereby improving heat dissipation of the laptop computer 100.

In some embodiments, the frame F may also be used to accommodate antenna module, speaker module, camera module, projecting module or other electronic components, and the invention is not limited to the embodiments presented and discussed above.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A laptop computer, comprising:
a main body;
a display unit, having a display and a connecting module connected to each other, wherein the connecting module is pivotally connected to the main body and has a housing, a front panel connected to the housing, and a movable member movably disposed on the bottom side of the front panel;
a connecting member, disposed in the housing and connected to the movable member;
a rack structure, disposed on the connecting member;
a longitudinal frame, disposed in the movable member; and
a gear set, connected between the main body and the rack structure, wherein when the display unit is unfolded relative to the main body, the gear set impels the connecting member, the movable member, and the frame in a first direction via the rack structure.

2. The laptop computer as claimed in claim 1, wherein the housing forms a slope surface, and when the display unit is unfolded relative to the main body, the frame slides out of the movable member along the slope surface.

3. The laptop computer as claimed in claim 2, wherein the housing has a protruding portion, and the slope surface is formed on the protruding portion.

4. The laptop computer as claimed in claim 2, wherein the front panel forms an opening, and the frame moves through the opening in a second direction when the display unit is unfolded relative to the main body.

5. The laptop computer as claimed in claim 4, wherein the second direction is perpendicular to the first direction.

6. The laptop computer as claimed in claim 1, wherein the rack structure is perpendicular to the frame.

7. The laptop computer as claimed in claim 1, further comprising a hinge affixed to the main body, wherein the gear set has a gear affixed to the hinge.

8. The laptop computer as claimed in claim 1, wherein a stylus pen is received in the frame, and when the display unit is folded relative to the main body, the frame and the stylus pen are hidden inside the movable member.

9. The laptop computer as claimed in claim 1, further comprising a hinge pivotally connecting the display to the connecting module.

10. The laptop computer as claimed in claim 1, further comprising a resilient member connected between the frame and the housing.
